(19) United States
(12) Patent Application Publication
(10) Pub. No.: US 2015/0006183 A1
(43) Pub. Date: Jan. 1, 2015

(54) ELECTRONIC DEVICE, CONTROL METHOD BY ELECTRONIC DEVICE, AND COMPUTER READABLE RECORDING MEDIUM

(71) Applicant: OLYMPUS CORPORATION, Tokyo (JP)

(72) Inventor: Yasutaka DAISHAKU, Sagamihara-shi (JP)

(21) Appl. No.: 14/315,199

(22) Filed: Jun. 25, 2014

(30) Foreign Application Priority Data
Jul. 1, 2013 (JP) 2013-138373

(51) Int. Cl. G10L 17/22

(52) U.S. Cl. CPC G10L 17/22
USPC 704/275

(57) ABSTRACT

An electronic device includes an operation input unit that receives a user operation, a voice data generation unit that generates voice data based on an input voice, an operation controller that operates the voice data generation unit while the user operation is continued, a related information recording unit that records related information in which a specific voice and a specific function are associated with each other, a voice determination unit that analyzes the voice data generated by the voice data generation unit and determines whether the specific voice contained in the related information has been input, and a function execution unit that, when the voice determination unit determines that the specific voice has been input, executes the function associated with the input specific voice based on the related information.

### CROSS-REFERENCE TO RELATED APPLICATIONS

This application is based upon and claims the benefit of priority from Japanese Patent Application No. 2013-138373, filed on Jul. 1, 2013, the entire contents of which are incorporated herein by reference.

### BACKGROUND OF THE INVENTION

1. Field of the Invention

The present invention relates to an electronic device, such as an imaging apparatus, a control method by the electronic device, and a computer readable recording medium.

2. Description of the Related Art

In recent years, there is a known technology for receiving user operations via touch panels provided on display screens of display units that display screens in electronic devices (see, for example, Japanese Laid-open Patent Publication No. 2010-232911).

If such touch panels are provided on the electronic devices, and by modifying display modes of screens displayed on the display units, it becomes possible to receive various user operations without providing a number of mechanical operation buttons.

### SUMMARY OF THE INVENTION

In accordance with some embodiments, an electronic device, a control method by the electronic device and a computer readable recording medium are presented.

In some embodiments, an electronic device includes: an operation input unit that receives a user operation; a voice data generation unit that generates voice data based on an input voice; an operation controller that operates the voice data generation unit while the user operation is continued and causes the voice data generation unit to generate voice data; a related information recording unit that records related information in which a specific voice and a specific function are associated with each other; a voice determination unit that analyzes the voice data generated by the voice data generation unit and determines whether the specific voice contained in the related information has been input; and a function execution unit that, when the voice determination unit determines that the specific voice has been input, executes the function associated with the input specific voice based on the related information.

In some embodiments, an electronic device includes: an operation input unit that receives a user operation; a voice acquisition unit that acquires a voice said by a user while the user is operating the operation input unit; a voice data generation unit that generates voice data based on the voice acquired by the voice acquisition unit; a complaint determination unit that determines whether the voice data generated by the voice data generation unit contains voice data corresponding to a complaint said by the user; a function display unit that, when the complaint determination unit determines that the voice data corresponding to the complaint said by the user is contained, displays a function for resolving the complaint said by the user based on the voice data; and a function execution unit that, when a predetermined function displayed on the function display unit is selected, executes the selected function.

In some embodiments, a control method performed by an electronic device is presented. The control method includes: operating a voice data generation unit while a user operation on an operation input unit is continued thereby causing the voice data generation unit to generate voice data; analyzing the voice data generated by the voice data generation unit to determine whether a specific voice contained in related information has been input, the related information being information in which the specific voice and a specific function are associated with each other; and executing, when it is determined that the specific voice has been input, the function associated with the input specific voice based on the related information.

In some embodiments, a control method performed by an electronic device is presented. The control method includes: determining a user operation performed on a specific operation input unit; operating a voice data generation unit while the user operation on the specific operation input unit is continued thereby causing the voice data generation unit to generate voice data; analyzing the voice data generated by the voice data generation unit to determine whether the voice data contains a specific keyword; and executing, when it is determined that the specific keyword is contained, the function associated with the specific keyword according to the user operation on the specific operation input unit.

In some embodiments, a control method performed by an electronic device is presented. The control method includes: acquiring a voice said by a user while the user is operating an operation input unit; generating voice data based on the acquired voice; determining whether the generated voice data contains voice data corresponding to a complaint said by the user; displaying, when it is determined that the voice data corresponding to the complaint said by the user is contained, a function for resolving the complaint said by the user based on the voice data; and executing a function selected by the user; wherein in the acquiring, the generating, the determining, the displaying, and the executing, the complaint said by the user is recognized based on the voice said by the user and the function desired by the user is displayed to aid the user to select the function, thereby the complaint said by the user who is not familiar with an operation is resolved.

In some embodiments, a non-transitory computer readable recording medium having an executable program recorded thereon is presented. The program instructs a processor, which is included in an electronic device, to execute: operating a voice data generation unit while a user operation on an operation input unit is continued thereby causing the voice data generation unit to generate voice data; analyzing the voice data generated by the voice data generation unit to determine whether a specific voice contained in related information has been input, the related information being information in which the specific voice and a specific function are associated with each other; and executing, when it is determined that the specific voice has been input, the function associated with the input specific voice based on the related information.

In some embodiments, a non-transitory computer readable recording medium having an executable program recorded thereon is presented. The program instructs a processor, which is included in an electronic device, to execute: determining a user operation performed on a specific operation input unit; operating a voice data generation unit while the user operation on the specific operation input unit is continued thereby causing the voice data generation unit to generate voice data; analyzing the voice data generated by the voice data generation unit to determine whether the voice data contains a specific keyword; and executing, when it is determined that the specific keyword is contained, the function associated with the specific keyword according to the user operation on the specific operation input unit.

In some embodiments, a non-transitory computer readable recording medium having an executable program recorded thereon is presented. The program instructs a processor, which is included in an electronic device, to execute: acquiring a voice said by a user while the user is operating an operation input unit; generating voice data based on the acquired voice; determining whether the generated voice data contains voice data corresponding to a complaint said by the user; displaying, when it is determined that the voice data corresponding to the complaint said by the user is contained, a function for resolving the complaint said by the user based on the voice data; and executing a function selected by the user; wherein in the acquiring, the generating, the determining, the displaying, and the executing, the complaint said by the user is recognized based on the voice said by the user and the function desired by the user is displayed to aid the user to select the function, thereby the complaint said by the user who is not familiar with an operation is resolved.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration of a user-facing side of an imaging apparatus according to a first embodiment of the present invention;

FIG. 2 is a block diagram illustrating a configuration of the imaging apparatus illustrated in FIG. 1;

FIG. 3 is a diagram illustrating an example of related information recorded in a flash memory illustrated in FIG. 2;

FIG. 4 is a flowchart illustrating operations of the imaging apparatus according to the first embodiment of the present invention;

FIG. 5 is a diagram schematically illustrating a situation in which a user performs shooting while checking a live view image (a live view image corresponding to image data generated by imaging a subject) displayed on a display unit;

FIG. 6A is a diagram schematically illustrating a situation in which the user performs a ring operation while checking the live view image;

FIG. 6B is a diagram schematically illustrating a situation in which the user performs a touch operation while checking the live view image;

FIG. 7 is a flowchart illustrating an overview of a voice handling process illustrated in FIG. 4;

FIG. 8A is a diagram illustrating an example of a live view image displayed on the display unit upon switch to an “MF mode” at Step S106F illustrated in FIG. 7;

FIG. 8B is a diagram illustrating an example of a live view image displayed on the display unit upon switch to an “exposure correction mode” at Step S106F illustrated in FIG. 7;

FIG. 8C is a diagram illustrating an example of a live view image displayed on the display unit upon switch to a “zoom mode” at Step S106F illustrated in FIG. 7;

FIG. 9 is a diagram illustrating an example of a parameter selection screen displayed on the display unit upon switch to a “Help mode” at Step S106F illustrated in FIG. 7;

FIG. 10A is a diagram illustrating an example of a keyboard input screen displayed on the display unit upon switch to a “keyboard mode” at Step S106F illustrated in FIG. 7;

FIG. 10B is a diagram illustrating an example of the keyboard input screen displayed on the display unit upon switch to the “keyboard mode” at Step S106F illustrated in FIG. 7;

FIG. 10C is a diagram illustrating an example of the keyboard input screen displayed on the display unit upon switch to the “keyboard mode” at Step S106F illustrated in FIG. 7; and

FIG. 11 is a flowchart illustrating an overview of a voice handling process according to a second embodiment of the present invention.

### DETAILED DESCRIPTION OF THE PREFERRED EMBODIMENTS

Exemplary embodiments (hereinafter, embodiments) of the present invention will be described below with reference to the drawings. The present invention is not limited to the embodiments described below. Furthermore, the same components are denoted by the same reference signs in the drawings.

### First Embodiment

### Schematic Configuration of Imaging Apparatus

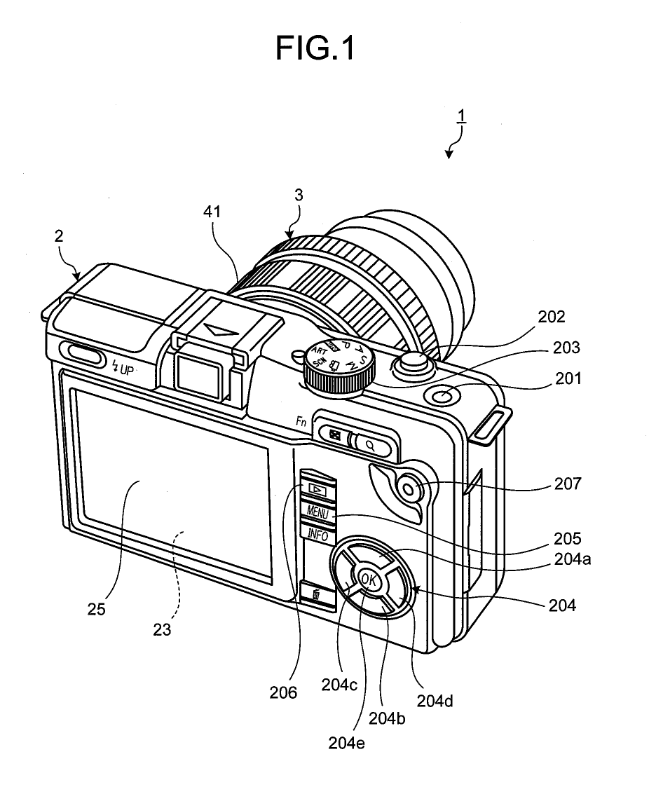

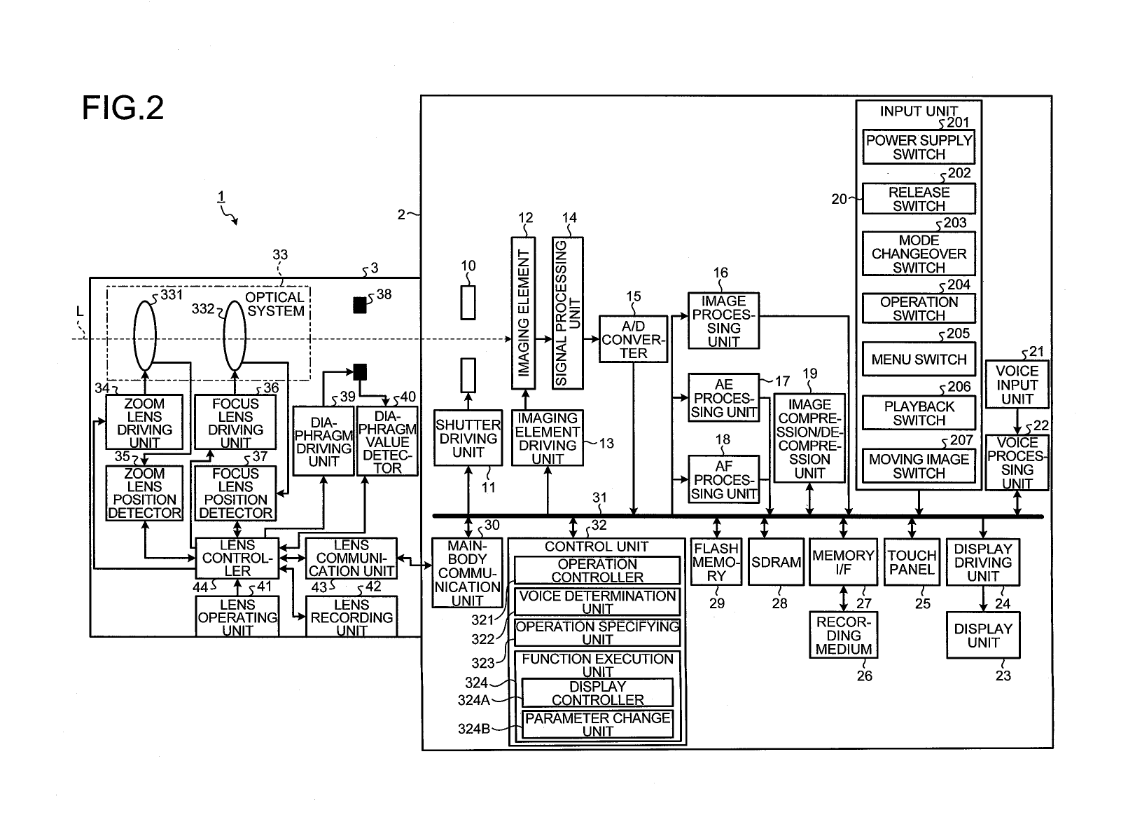

FIG. 1 is a perspective view illustrating a configuration of a user facing side (front side) of an imaging apparatus 1 according to a first embodiment of the present invention. FIG. 2 is a block diagram illustrating a configuration of the imaging apparatus 1.

The imaging apparatus 1 includes, as illustrated in FIG. 1 and FIG. 2, a main body 2 and a lens unit 3 detachably attached to the main body 2.

The imaging apparatus 1 functions as an electronic device according to the present invention.

### Configuration of Main Body

The main body 2 includes, as illustrated in FIG. 2, a shutter 10, a shutter driving unit 11, an imaging element 12, an imaging element driving unit 13, a signal processing unit 14, an A/D converter 15, an image processing unit 16, an AE processing unit 17, an AF processing unit 18, an image compression/decompression unit 19, an input unit 20, a voice input unit 21, a voice processing unit 22, a display unit 23, a display driving unit 24, a touch panel 25, a recording medium 26, a memory I/F 27, a synchronous dynamic random access memory (SDRAM) 28, a flash memory 29, a main-body communication unit 30, a bus 31, a control unit 32, and the like.

The shutter 10 sets a state of the imaging element 12 to an exposed state or a light-blocked state.

The shutter driving unit 1 is configured by using a stepping motor or the like, and drives the shutter 10 according to an instruction signal input from the control unit 32.

The imaging element 12 is configured by using a charge coupled device (CCD), a complementary metal oxide semiconductor (CMOS), or the like that receives light collected by the lens unit 3 and converts the light to an electrical signal.

The imaging element driving unit 13 outputs image data (analog signal) from the imaging element 12 to the signal processing unit 14 at a predetermined timing according to an instruction signal input from the control unit 32. In this sense, the imaging element driving unit 13 functions as an electronic shutter.

The signal processing unit 14 performs analog processing on the analog signal input from the imaging element 12, and outputs the processed signal to the A/D converter 15.

Specifically, the signal processing unit 14 performs a noise reduction process, a gain-up process, and the like on the analog signal. For example, the signal processing unit 14 reduces reset noise or the like from the analog signal, performs waveform shaping, and performs gain-up to obtain desired brightness.

The A/D converter 15 performs A/D conversion on the analog signal input from the signal processing unit 14 to generate digital image data, and outputs the digital image data to the SDRAM 28 via the bus 31.

The imaging element 12, the signal processing unit 14, and the A/D converter 15 as described above function as an imaging unit according to the present invention.

The image processing unit 16 acquires image data from the SDRAM 28 via the bus 31 and performs various image processing on the acquired image data under control of the control unit 32. The image data subjected to the image processing is output to the SDRAM 28 via the bus 31.

The AE processing unit 17 acquires image data stored in the SDRAM 28 via the bus 31, and sets an exposure condition for performing still image shooting or moving image shooting based on the acquired image data.

Specifically, the AE processing unit 17 calculates luminance from the image data, and determines, for example, a diaphragm value, an exposure time, an ISO sensitivity, or the like based on the calculated luminance to perform automatic exposure (Auto Exposure) of the imaging apparatus 1.

The AF processing unit 18 acquires image data stored in the SDRAM 28 via the bus 31, and adjusts autofocus of the imaging apparatus 1 based on the acquired image data. For example, the AF processing unit 18 extracts a signal of a high-frequency component from the image data, performs an AF (Auto Focus) calculation process on the signal of the high-frequency component to determine focusing evaluation of the imaging apparatus 1, and adjusts the autofocus of the imaging apparatus 1.

As a method of adjusting the autofocus of the imaging apparatus 1, it may be possible to employ a method of acquiring a phase difference signal by an imaging element or a method of providing a dedicated AF optical system.

The image compression/decompression unit 19 acquires image data from the SDRAM 28 via the bus 31, compresses the acquired image data according to a predetermined format, and outputs the compressed image data to the SDRAM 28. A still image compression method is a JPEG (Joint Photographic Experts Group) method. A moving image compression method is a Motion JPEG method, an MP4 (H.264) method, or the like. The image compression/decompression unit 19 also acquires image data (compressed image data) recorded in the recording medium 26 via the bus 31 and the memory I/F 27, expands (decompresses) the acquired image data, and outputs the expanded image data to the SDRAM 28.

The input unit 20 includes, as illustrated in FIG. 1, a power supply switch 201 that switches a power supply state of the imaging apparatus 1 to an on-state or an off-state; a release switch 202 that receives input of a still image release signal to give an instruction on still image shooting; a mode changeover switch 203 that switches between various modes (a shooting mode (a still image shooting mode and a moving image shooting mode), a playback mode, and the like) of the imaging apparatus 1; an operation switch 204 that switches between various settings of the imaging apparatus 1; a menu switch 205 that displays, on the display unit 23, various settings of the imaging apparatus 1; a playback switch 206 that displays, on the display unit 23, an image corresponding to image data recorded in the recording medium 26; a moving image switch 207 that receives input of a moving image release signal to give an instruction on moving image shooting; and the like.

The release switch 202 is able to move back and forth in response to external pressure, receives input of a first release signal designating shooting preparation operation when being pressed halfway, and receives input of a second release signal designating still image shooting when being fully pressed.

The operation switch 204 includes upward, downward, leftward, and rightward directional switches 204a to 204d to perform selection and setting on the menu screen or the like, and a confirmation switch 204e (OK switch) to confirm operation by the directional switches 204a to 204d on the menu screen or the like (FIG. 1). The operation switch 204 may be configured by using a dial switch or the like.

The voice input unit 21 has a function as a voice acquisition unit according to the present invention, is configured by using a microphone, inputs voice, and converts the voice to an electrical signal. While the microphone is not illustrated in FIG. 1, if the microphone is arranged on a top side of the imaging apparatus 1, it becomes easy to collect both of voice of an object and voice of a photographer. If each voice is to be collected separately, the microphone may be arranged on a front side (the lens unit 3 side) or a back side (the display unit 23 side) of the imaging apparatus 1. In particular, according to the present invention, if the microphone is arranged on the back side, it becomes possible to easily eliminate the influence of noise and prevent erroneous operations.

The voice processing unit 22 performs A/D conversion by performing sampling and quantization on the electrical signal converted by the voice input unit 21 and generates voice data under control of the control unit 32. The generated voice data is output to the SDRAM 28 via the bus 31.

The voice input unit 21 and the voice processing unit 22 as described above function as a voice data generation unit according to the present invention.

The display unit 23 has a function as a function display unit according to the present invention, and is configured by using a display panel made of liquid crystal, organic EL (Electro Luminescence), or the like.

The display driving unit 24 acquires, under control of the control unit 32, image data stored in the SDRAM 28 via the bus 31 or image data recorded in the recording medium 26, and displays an image corresponding to the acquired image data on the display unit 23.

Display of the image includes a rec view display to display image data for a predetermined time immediately after shooting, a playback display to playback image data recorded in the recording medium 26, a live view display to sequentially display live view images corresponding to pieces of image data sequentially generated by the imaging element 12 in chronological order, and the like.

Furthermore, the display unit 23 appropriately displays information on operation or shooting by the imaging apparatus 1.

The touch panel 25 is, as illustrated in FIG. 1, provided on a display screen of the display unit 23, detects touch of an external object, and outputs a position signal corresponding to the detected touch position.

In general, a resistive touch panel, a capacitive touch panel, an optical touch panel, and the like are known as a touch panel. In the first embodiment, any type of touch panel may be employed as the touch panel 25.

The touch panel 25 functions as an operation input unit according to the present invention.

Hereinafter, a user operation for touching the touch panel 25 is described as a “touch operation”.

The recording medium 26 is configured by using a memory card or the like to be attached from outside the imaging apparatus 1, and is detachably attached to the imaging apparatus 1 via the memory I/F 27.

In the recording medium 26, the image data subjected to processing by the image processing unit 16 or the image compression/decompression unit 19 is written by a corresponding type of read/write device (not illustrated). Or, the read/write device reads out image data recorded in the recording medium 26. Furthermore, the recording medium 26 may output programs or various types of information to the flash memory 29 via the memory I/F 27 and the bus 31 under control of the control unit 32.

The SDRAM 28 is configured by using a volatile memory, and temporarily stores therein image data input from the A/D converter 15 via the bus 31, image data input from the image processing unit 16, and information being processed by the imaging apparatus 1.

For example, the SDRAM 28 temporarily stores therein pieces of image data sequentially output for each frame by the imaging element 12 via the signal processing unit 14, the A/D converter 15, and the bus 31.

The flash memory 29 is configured by using a nonvolatile memory.

The flash memory 29 records therein various programs (including a control program according to the present invention) for operating the imaging apparatus 1, various types of data used during execution of the programs, various parameters needed for execution of the image processing by the image processing unit 16, or the like.

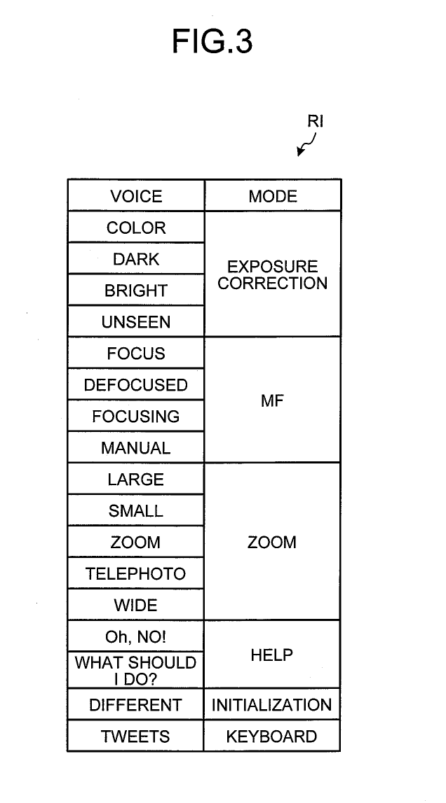

FIG. 3 is a diagram illustrating an example of related information recorded in the flash memory 29.

Related information RI illustrated in FIG. 3 is an example of various types of data used during execution of the programs.

The related information RI is information in which a specific voice (keyword) and a specific function (each mode for changing a shooting parameter) are associated with each other.

Specifically, the related information RI contains information in which voices such as “color”, “dark”, “bright”, and “unseen” related to an exposure state of an image to be captured are associated with an “exposure correction mode” for changing an exposure value (a diaphragm value, a shutter speed, or the like) that is a shooting parameter (exposure condition).

Furthermore, the related information RI contains information in which voices such as “focus”, “defocused”, “focusing”, and “manual” related to a focus state of an image to be captured are associated with a “manual focus (MF) mode” for changing a focal point and a focal distance that are shooting parameters.

Moreover, the related information RI contains information in which voices such as “large”, “small”, “zoom”, “telephoto”, and “wide” related to a shooting range are associated with a “zoom mode” for changing a zoom magnification that is a shooting parameter.

Furthermore, the related information RI contains information in which voices such as “Oh, no!” and “What should I do?” indicating that the way to operate is unclear and a “Help mode” for helping to select one of the exposure correction mode, the MF mode, and the zoom mode as described above are associated with each other.

Moreover, the related information RI, in which a voice such as “tweets” indicating that a message is to be written and a “keyboard mode” for writing messages are associated with each other.

Furthermore, the related information RI contains information in which a negative voice such as “different” is associated with an “initialization mode” for terminating the exposure correction mode, the MF mode, the zoom mode, the Help mode, and the keyboard mode as described above and for initializing the shooting parameters to default values.

As described above, the flash memory 29 also functions as a related information recording unit according to the present invention.

The main-body communication unit 30 is a communication interface for communicating with the lens unit 3 mounted on the main body 2.

The bus 31 is configured by using a transmission path or the like that connects the components of the imaging apparatus 1, and transfers various types of data generated inside the imaging apparatus 1 to each of the components of the imaging apparatus 1.

The control unit 32 is configured by using a central processing unit (CPU) or the like, and integrally controls operations of the imaging apparatus 1 by, for example, transferring corresponding instructions or data to each of the components of the imaging apparatus 1 in accordance with the instruction signal or the release signal from the input unit 20 or the position signal from the touch panel 25 via the bus 31. For example, when the second release signal is input, the control unit 32 causes the imaging apparatus 1 to start a shooting operation. The shooting operation by the imaging apparatus 1 indicates an operation to cause the signal processing unit 14, the A/D converter 15, and the image processing unit 16 to perform predetermined processes on image data output by the imaging element 12 by driving the shutter driving unit 11 and the imaging element driving unit 13. The image data processed as described above is compressed by the image compression/decompression unit 19 and recorded in the recording medium 26 via the bus 31 and the memory I/F 27 under control of the control unit 32. Furthermore, when the control unit 32 causes the shooting operation to start as described above, if a shooting parameter is changed in the “exposure correction mode”, the “MF mode”, or the “zoom mode”, the control unit 32 drives the shutter driving unit 11, the imaging element driving unit 13, the lens unit 3 (a diaphragm driving unit 39, a focus lens driving unit 36, and a zoom lens driving unit 34 to be described later) to perform the shooting operation with the changed shooting parameter.

The control unit 32 includes, as illustrated in FIG. 2, an operation controller 321, a voice determination unit 322, an operation specifying unit 323, a function execution unit 324, and the like.

The operation controller 321 controls operations of the voice processing unit 22 according to user operations on the touch panel 25 or a lens operating unit 41.

The voice determination unit 322 analyzes the voice data generated by the voice processing unit 22 and determines whether a specific voice contained in the related information RI recorded in the flash memory 29 has been input.

When the voice determination unit 322 determines that the specific voice has been input, the operation specifying unit 323 specifies which one of the touch panel 25 and the lens operating unit 41 is an operation input that has received a user operation by which input of the specific voice has been triggered. Then, the operation specifying unit 323 sets the specified operation input unit as a change operation input unit that receives operations of changing the shooting parameters.

When the voice determination unit 322 determines that the specific voice has been input, the function execution unit 324 executes a function associated with the specific voice based on the related information RI recorded in the flash memory 29.

The function execution unit 324 includes, as illustrated in FIG. 2, a display controller 324A, a parameter change unit 324B, and the like.

The display controller 324A causes the display unit 23 to perform the rec view display, the playback display, and the live view display, and displays a parameter change screen and a parameter selection screen (Help screen) on the display unit 23 when the voice determination unit 322 determines that the specific voice has been input.

The parameter change screen is a screen provided for each of the “exposure correction mode”, the “MF mode”, and the “zoom mode”, and helps to change shooting parameters according to each mode.

The parameter selection screen is a screen that helps to select a shooting parameter to be changed.

The parameter change unit 324B executes, when the parameter change screen corresponding to each mode is being displayed on the display unit 23, a parameter change process of changing the shooting parameters corresponding to each mode according to a user operation on the change operation input unit set by the operation specifying unit 323.

The main body 2 configured as described above may be provided with a voice input/output function, a flash function, a removable electronic viewfinder (EVF), a communication unit capable of performing bidirectional communication with external processors such as personal computers via the Internet, or the like.

### Configuration of Lens Unit

The lens unit 3 includes, as illustrated in FIG. 2, an optical system 33, the zoom lens driving unit 34, a zoom lens position detector 35, the focus lens driving unit 36, a focus lens position detector 37, a diaphragm 38, the diaphragm driving unit 39, a diaphragm value detector 40, the lens operating unit 41, a lens recording unit 42, a lens communication unit 43, and a lens controller 44.

The optical system 33 condenses light from a predetermined field area, and focuses the condensed light on an imaging plane of the imaging element 12. The optical system 33 includes, as illustrated in FIG. 2, a zoom lens 331 and a focus lens 332.

The zoom lens 331 is configured by using one or more lenses, and moves along an optical axis L (FIG. 2) to change a zoom factor of the optical system 33.

The focus lens 332 is configured by using one or more lenses, and moves along the optical axis L to change a focal point and a focal distance of the optical system 33.

The zoom lens driving unit 34 is configured by using a stepping motor, a DC motor, or the like, and moves the zoom lens 331 along the optical axis L under control of the lens controller 44.

The zoom lens position detector 35 is configured by using a photo interrupter or the like, and detects the position of the zoom lens 331 driven by the zoom lens driving unit 34.

Specifically, the zoom lens position detector 35 converts the amount of rotation of a driving motor included in the zoom lens driving unit 34 into the number of pulses, and detects the position of the zoom lens 331 on the optical axis L from a reference position based on the infinity in accordance with the number of pulses obtained by the conversion.

The focus lens driving unit 36 is configured by using a stepping motor, a DC motor, or the like, and moves the focus lens 332 along the optical axis L under control of the lens controller 44.

The focus lens position detector 37 is configured by using a photo interrupter or the like, and detects, on the optical axis L, the position of the focus lens 332 driven by the focus lens driving unit 36 in the same manner as employed by the zoom lens position detector 35.

The diaphragm 38 adjusts exposure by limiting the incident amount of light condensed by the optical system 33.

The diaphragm driving unit 39 is configured by using a stepping motor or the like, and drives the diaphragm 38 to adjust the amount of light incident on the imaging element 12 under control of the lens controller 44.

The diaphragm value detector 40 detects the state of the diaphragm 38 driven by the diaphragm driving unit 39 to detect a diaphragm value of the diaphragm 38. The diaphragm value detector 40 is configured by using a potentiometer such as a linear encoder or a variable resistive element, an A/D converter circuit, or the like.

The lens operating unit 41 is, as illustrated in FIG. 1, a ring operating member arranged around a lens barrel of the lens unit 3, and is rotatable around the optical axis L. The lens operating unit 41 receives input of instruction signals to instruct the zoom lens 331 or the focus lens 332 in the optical system 33 to operate or to instruct the imaging apparatus 1 to operate. The lens operating unit 41 may be a push-type switch or the like.

The lens operating unit 41 functions as the operation input unit according to the present invention, together with the touch panel 25.

Hereinafter, a user operation for rotating the lens operating unit 41 is described as a “ring operation”.

The lens recording unit 42 records therein control programs for determining the positions and operations of the optical system 33 and the diaphragm 38, a magnification, a focal distance, an angle of view, an aberration, and an F value (brightness) of the optical system 33, or the like.

The lens communication unit 43 is a communication interface for communicating with the main-body communication unit 30 of the main body 2 when the lens unit 3 is mounted on the main body 2.

The lens controller 44 is configured by using a CPU or the like, and controls operations of the lens unit 3 in accordance with an instruction signal or a drive signal input from the control unit 32 via the main-body communication unit 30 and the lens communication unit 43. Furthermore, the lens controller 44 outputs, to the control unit 32, the position of the zoom lens 331 detected by the zoom lens position detector 35 via the main-body communication unit 30 and the lens communication unit 43, the position of the focus lens 332 detected by the focus lens position detector 37, and the diaphragm value of the diaphragm 38 detected by the diaphragm value detector 40.

### Operations of Imaging Apparatus

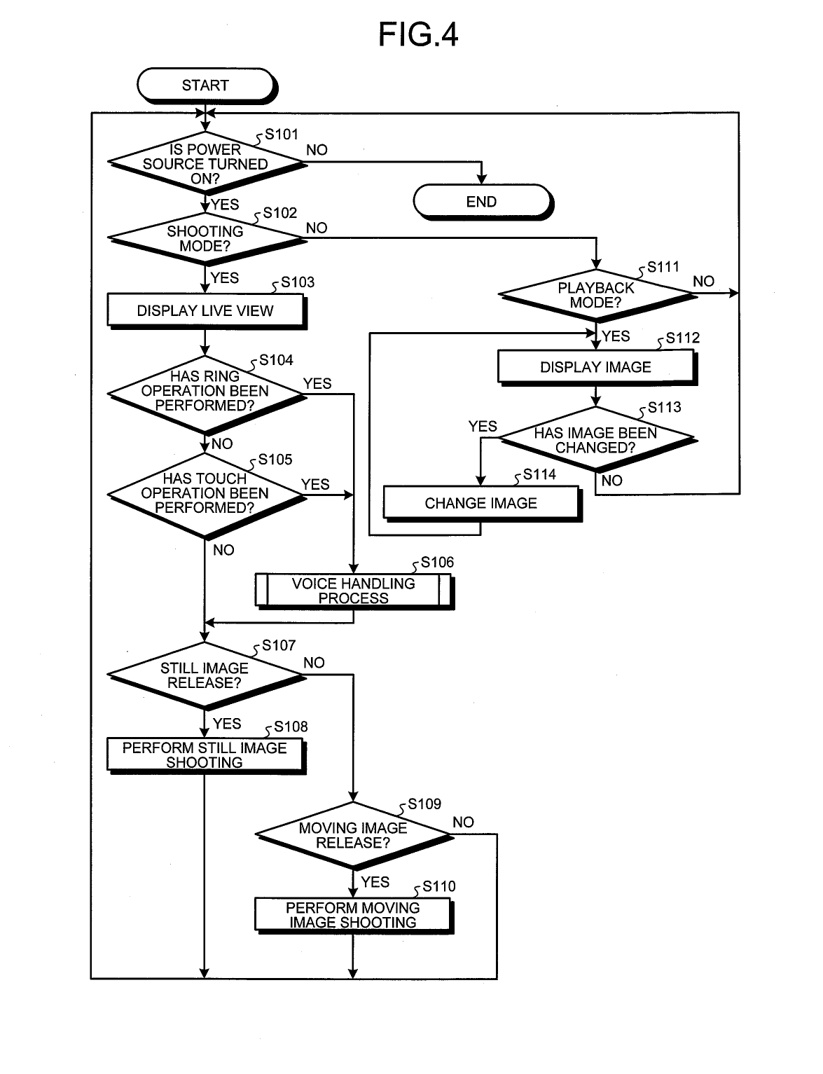

FIG. 4 is a flowchart illustrating operations of the imaging apparatus 1 according to the first embodiment.

The operations of the above described imaging apparatus 1 (a control method by the electronic device according to the present invention) will be described below based on FIG. 4.

When a user operates the power supply switch 201 and a power source of the imaging apparatus 1 is turned on (Step S101: Yes), the control unit 32 determines whether the imaging apparatus 1 is set to the shooting mode by a user operation on the mode changeover switch 203 (Step S102).

When it is determined that the imaging apparatus 1 is set to the shooting mode (Step S102: Yes), the display controller 324A starts to display a live view image on the display unit 23 (Step S103).

Specifically, the control unit 32 drives the imaging element driving unit 13 to perform shooting by the electronic shutter. The image processing unit 16 performs various image processing on the image data that is generated by the imaging element 12 through the shooting by the electronic shutter and that is stored in the SDRAM 28. The display controller 324A displays, on the display unit 23, a live view image corresponding to the image data that is subjected to the image processing by the image processing unit 16 and that is stored in the SDRAM 28.

Subsequently, the control unit 32 determines whether the user has performed a ring operation (Step S104).

When determining that the ring operation has not been performed (Step S104: No), the control unit 32 determines whether the user has performed a touch operation (Step S105).

In contrast, when determining that the ring operation has been performed (Step S104: Yes), the control unit 32 performs a voice handling process of changing a shooting parameter according to a voice of the user (Step S106). Furthermore, in this case (Step S104: Yes), the operation specifying unit 323 sets a ring operation flag indicating execution of the ring operation to an on-state, and sets a touch operation flag indicating execution of the touch operation to an off-state. The ring operation flag and the touch operation flag are stored in the SDRAM 28.

When determining that the touch operation has been performed (Step S105: Yes), the control unit 32 performs the voice handling process (Step S106). Furthermore, in this case (Step S105: Yes), the operation specifying unit 323 sets the ring operation flag to an off-state, and sets the touch operation flag to an on-state.

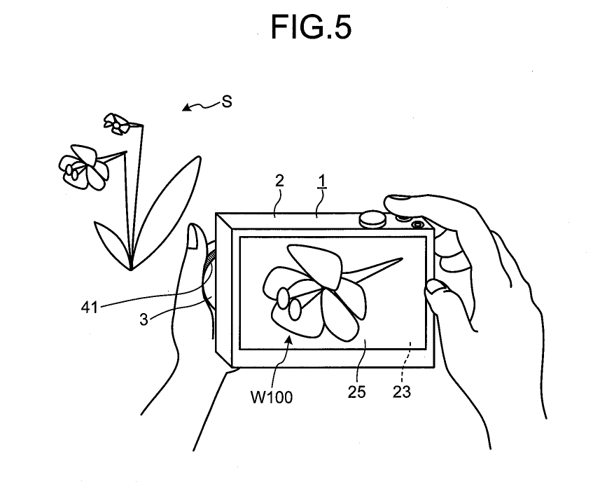

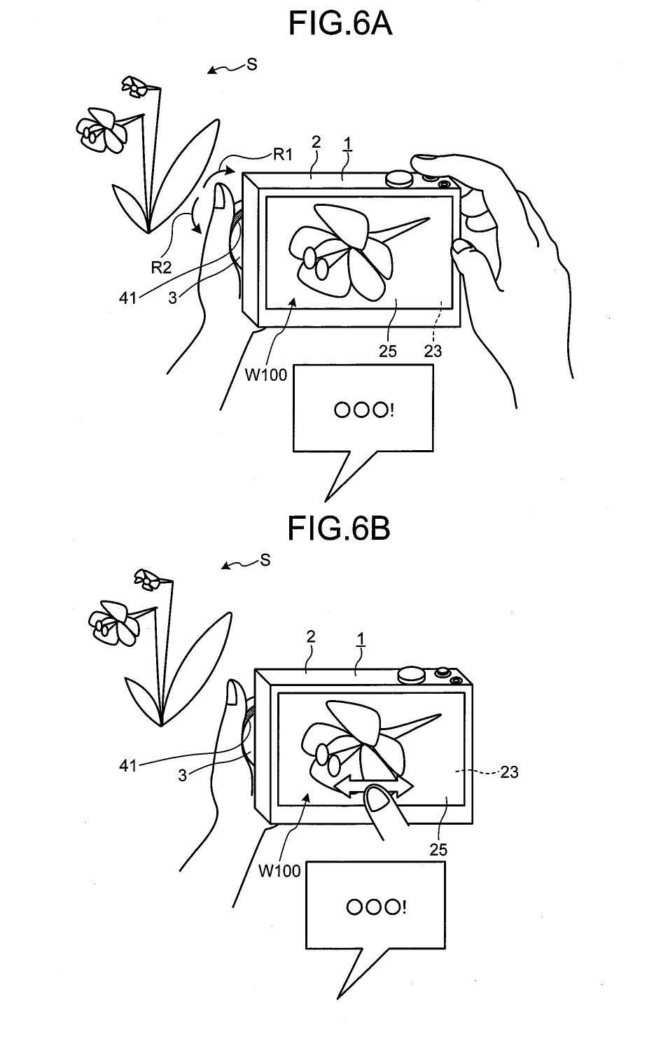

FIG. 5 is a diagram schematically illustrating a situation in which the user performs shooting while checking a live view image W100 (a live view image corresponding to image data generated by imaging a subject S (flower)) being displayed on the display unit 23. FIG. 6A is a diagram schematically illustrating a situation in which the user performs the ring operation while checking the live view image W100. FIG. 6B is a diagram schematically illustrating a situation in which the user performs the touch operation while checking the live view image W100.

When performing a shooting operation (an operation on the release switch 202 or the moving image switch 207), the user holds the imaging apparatus 1 as illustrated in FIG. 5.

Specifically, the user supports the main body 2 with the palm of a left hand and places left fingers on the lens unit 3. Furthermore, the user places a right hand on the main body 2 so as to be able to operate the release switch 202 and the like.

As described above, the user performs the shooting operation by checking the live view image W100 while holding the imaging apparatus 1.

Incidentally, in some cases, the user may want to change an exposure state or a focus state of an image or a shooting range as a result of checking the live view image W100, but may not know how to operate.

In such a case, as illustrated in FIG. 6A and FIG. 6B, it is expected that the user complains (says words of complaints or the like) while performing the ring operation in directions of arrows R1 and R2 (FIG. 6A) or performing the touch operation of sliding a finger on the touch panel 25.

In the first embodiment, the user operation expected as described above is detected (Steps S104 and S105), and, at Step S106, the exposure state, the focus state, or the shooting range is changed as desired by the user in accordance with the words said by the user.

Details of the voice handling process (Step S106) will be described later.

When determining that the touch operation has not been performed (Step S105: No), or after the voice handling process has been performed (Step S106), the control unit 32 determines whether the second release signal has been input from the release switch 202 (Step S107).

When determining that the second release signal has been input (Step S107: Yes), the control unit 32 performs still image shooting (Step S108) and returns to Step S101.

Specifically, at Step S108, the control unit 32 performs shooting by a mechanical shutter by driving the shutter driving unit 11 and the imaging element driving unit 13. Furthermore, the image processing unit 16 performs various image processing on the image data that is generated by the imaging element 12 through the shooting by the mechanical shutter and that is stored in the SDRAM 28. The image compression/decompression unit 19 compresses the image data that is subjected to the image processing by the image processing unit 16 and that is stored in the SDRAM 28, and records the compressed image data in the recording medium 26.

In contrast, when determining that the second release signal has not been input (Step S107: No), the control unit 32 determines whether the moving image release signal has been input from the moving image switch 207 (Step S109).

When determining that the moving image release signal has been input (Step S109: Yes), the control unit 32 performs moving image shooting (Step S110) and returns to Step S101.

Specifically, at Step S110, the control unit 32 performs shooting by the electronic shutter by driving the imaging element driving unit 13. Furthermore, the image processing unit 16 performs various image processing on the image data that is generated by the imaging element 12 through the shooting by the electronic shutter and that is stored in the SDRAM 28. The image compression/decompression unit 19 compresses the image data that is subjected to the image processing by the image processing unit 16 and that is stored in the SDRAM 28, and records the compressed image data, as a moving image, in a moving image file generated in the recording medium 26.

When determining that the moving image release signal has not been input (Step S109: No), the control unit 32 returns to Step S101.

At Step S101, when determining that the power source of the imaging apparatus 1 is turned off (Step S101: No), the control unit 32 ends the process.

Referring back to Step S102, when determining that the imaging apparatus 1 is not set to the shooting mode (Step S102: No), the control unit 32 determines whether the imaging apparatus 1 is set to the playback mode by a user operation on the mode changeover switch 203 (Step S111).

When determining that the imaging apparatus 1 is not set to the playback mode (Step S111: No), the imaging apparatus 1 returns to Step S101.

In contrast, when it is determined that the imaging apparatus 1 is set to the playback mode (Step S111: Yes), the display controller 324A displays, on the display unit 23, an image corresponding to the image data recorded in the recording medium 26 (Step S112).

Subsequently, the display controller 324A determines whether an instruction signal designating a change of images has been input by a user operation on the input unit 20 or the touch panel 25 (Step S113).

When determining that the instruction signal designating a change of images has been input (Step S113: Yes), the display controller 324A changes the image displayed on the display unit 23 (Step S114). After Step S114, the imaging apparatus 1 returns to Step S112.

In contrast, when determining that the instruction signal designating a change of images has not been input (Step S113: No), the imaging apparatus 1 returns to Step S101.

### Voice Handling Process

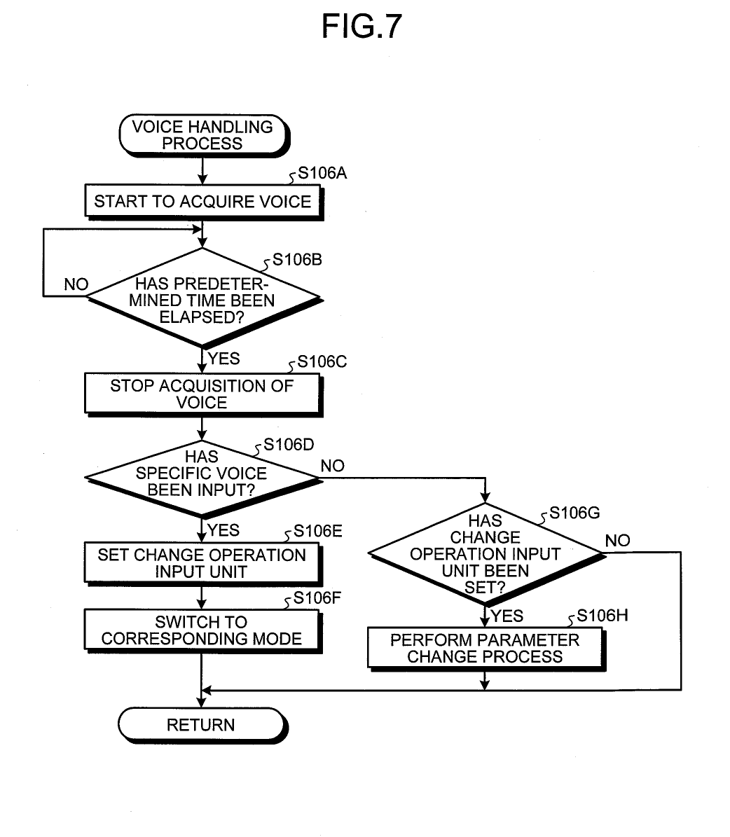

FIG. 7 is a flowchart illustrating an overview of the voice handling process.

The voice handling process (Step S106) illustrated in FIG. 4 will be described below based on FIG. 7.

When it is determined that the ring operation has been performed (Step S104: Yes), or when it is determined that the touch operation has been performed (Step S105: Yes), the operation controller 321 causes the voice processing unit 22 to operate and start to generate voice data (start to acquire voices) (Step S106A).

Specifically, as illustrated in FIG. 6A and FIG. 6B, the words said by the user are input to the voice input unit 21, converted to electrical signals, and generated as voice data by the voice processing unit 22.

Subsequently, the operation controller 321 continuously monitors whether a predetermined time has elapsed since the start of the ring operation or the touch operation (Step S106B), and if the predetermined time has elapsed (Step S106B: Yes), causes the voice processing unit 22 to stop the operation (stop acquiring voices) (Step S106C).

The voice data generated during Steps S106A to S106C is output to the SDRAM 28 via the bus 31. Then, the voice data that has been stored in the SDRAM 28 is updated with the latest voice data.

Steps S106A to S106C as described above corresponds to an operation control step according to the present invention.

Subsequently, the voice determination unit 322 reads the voice data from the SDRAM 28 and analyzes the read voice data. The voice determination unit 322 determines whether the voice data contains a specific voice contained in the related information RI recorded in the flash memory 29 (whether the specific voice has been input) (Step S106D: a voice determination step).

If the specific voice has been input (Step S106D: Yes), the operation specifying unit 323 specifies which one of the touch panel 25 and the lens operating unit 41 is an operation input unit that has received a user operation by which input of the specific voice has been triggered.

Specifically, the operation specifying unit 323 checks the ring operation flag and the touch operation flag stored in the SDRAM 28. The operation specifying unit 323 specifies an operation input unit corresponding to the operation flag in the on-state as the operation input unit that has received the user operation by which input of the specific voice has been triggered.

The operation specifying unit 323 sets the specified operation input unit as the change operation input unit that receives operations of changing the shooting parameters (Step S106E).

If the input specific voice is “tweets”, the operation specifying unit 323 sets the touch panel 25 as the change operation input unit regardless of whether the ring operation flag and the touch operation flag are on-states or off-states.

Information set by the operation specifying unit 323 is output to the SDRAM 28 via the bus 31.

Subsequently, the function execution unit 324 switches to a mode corresponding to the input specific voice based on the related information RI recorded in the flash memory 29 (Step S106F). The display controller 324A displays an image corresponding to the switched mode on the display unit 23 as described below.

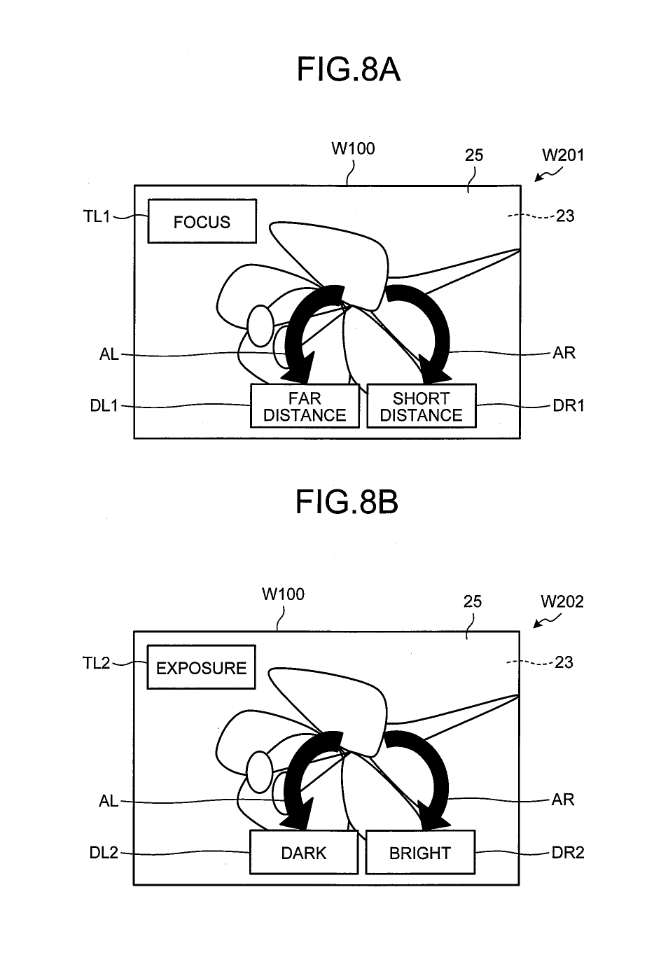

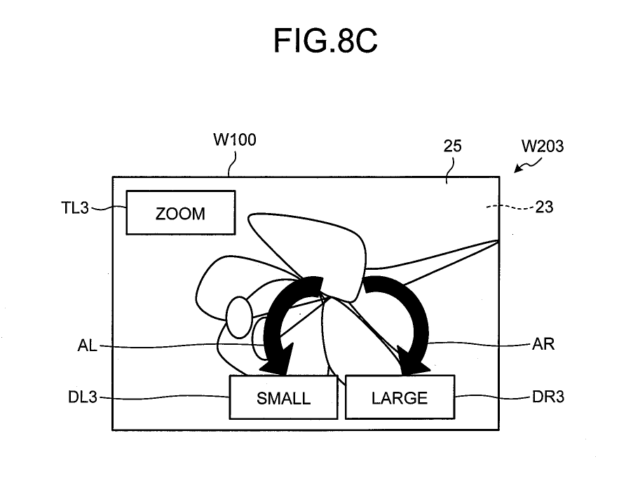

FIG. 8A to FIG. 8C are diagrams illustrating examples of live view images W201 to W203 displayed on the display unit 23 upon switch to the “MF mode”, the “exposure correction mode”, and the “zoom mode” at Step S106F, respectively.

When a voice related to the focus state of an image to be captured is input (Step S106D: Yes), and switching to the “MF mode” is performed (Step S106F), the display controller 324A displays the live view image W201 illustrated in FIG. 8A on the display unit 23.

Specifically, the live view image W201 is an image obtained by superimposing a title image TL1, directional images AR and AL, and description images DR1 and DL1 on the live view image W100.

The title image TL1 is an image representing a title of the switched mode. In the example in FIG. 8A, a text “focus” is displayed.

The directional images AR and AL are images that correspond to the rotation directions of the lens operating unit 41 (the arrows R1 and R2 (FIG. 6A)) and indicate operation directions for changing a state.

The description images DR1 and DL1 are images for describing states to be changed by the ring operation and the touch operation in the operation directions based on the directional images AR and AL. In the example in FIG. 8A, a text “short distance” and a text “long distance” are displayed.

Namely, the live view image W201 corresponds to a parameter change screen that helps to change a focal point and a focal distance that are shooting parameters.

When a voice related to the exposure state of an image is input (Step S106D: Yes), and switching to the “exposure correction mode” is performed (Step S106F), the display controller 324A displays the live view image W202 illustrated in FIG. 8B on the display unit 23.

Specifically, the live view image W202 is an image obtained by superimposing a title image TL2, the directional images AR and AL, and description images DR2 and DL2 on the live view image W100, similarly to the live view image W201.

In the example in FIG. 8B, a text “exposure” is displayed as the title image TL2. Furthermore, a text “bright” and a text “dark” are displayed as the description images DR2 and DL2, respectively.

Namely, the live view image W202 corresponds to a parameter change screen that helps to change an exposure value that is a shooting parameter.

When a voice related to the shooting range is input (Step S106D: Yes), and switching to the “zoom mode” is performed (Step S106F), the display controller 324A displays the live view image W203 illustrated in FIG. 8C on the display unit 23.

Specifically, the live view image W203 is an image obtained by superimposing a title image TL3, the directional images AR and AL, and description images DR3 and DL3 on the live view image W100, similarly to the live view images W201 and W202.

In the example n FIG. 8C, a text “zoom” is displayed as the title image TL3. Furthermore, a text “large” and a text “small” are displayed as the description images DR3 and DL3, respectively.

Namely, the live view image W203 corresponds to a parameter change screen that helps to change a zoom magnification that is a shooting parameter.

The user checks one of the live view images W201 to W203, and when determining that a function (a change in the focus state, the exposure state, or the shooting range) that the user wants to execute by the imaging apparatus 1 is correct, the user operates the operation input unit (the lens operating unit 41 or the touch panel 25) according to the display (the directional images AR and AL) in order to execute the function. In this manner, it is only necessary to determine a voice (voice data) at a timing close to a timing at which the operation input unit is operated. Therefore, it becomes possible to analyze voice data only when needed, enable a power-saving design, and accurately determine user's complaints while enabling temporal filtering and without being influenced or disturbed by other voices.

Furthermore, it becomes possible to perform related operations (operations of executing desired functions) by operating the operation input unit. Therefore, it becomes possible to switch to prompt operations (even more, operations that may be desired by the user) without shifting to other operating members, and to comfortably enjoy use of the apparatus by stress-free operations without causing erroneous operations.

In particular, as in the present embodiment, if the imaging apparatus 1 is employed as the electronic device according to the present invention, it becomes possible not to miss a best moment to be captured. Furthermore, even when an emergency safety device or the like is to be operated, a user interface based on the above described idea is effective. Namely, the reliability is increased as compared with operations based on only voices, and erroneous operations are less likely to occur. Moreover, in the present embodiment, occurrence of erroneous operations is further prevented by combining display of texts as described above (the description images DR1 to DR3, DL1 to DL3, and the like).

In other words, the followings steps are executed: an operation determination step of determining a user operation on a specific operation input unit (Steps S104 and S105 (the control unit 32 has a function as an operation determination unit that performs this step)); the operation control step of operating the voice data generation unit (the voice input unit 21 and the voice processing unit 22) when the user operation performed on the specific operation unit is determined at the operation determination step (Steps S106A to S106C); the voice determination step of analyzing voice data generated at the operation control step and determining whether the voice data contains a specific keyword (Step S106D); and a function execution step of enabling the operation input unit to perform a function associated with the specific keyword when it is determined that the specific keyword is contained at the voice determination step (Steps S106F and S106H). Therefore, it becomes possible to provide an electronic device control method for controlling the electronic device reliably and promptly while taking into account energy saving.

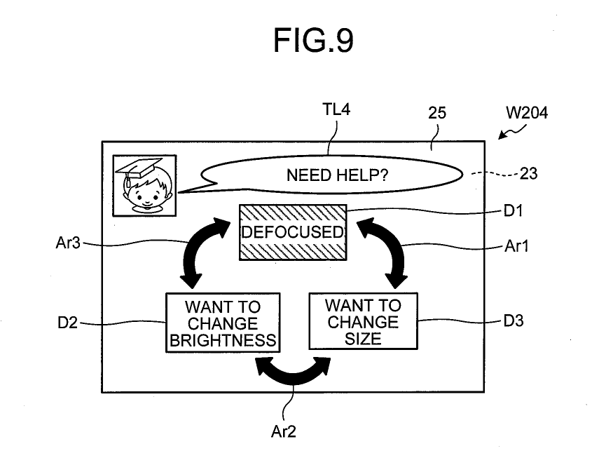

FIG. 9 is a diagram illustrating an example of a parameter selection screen W204 displayed on the display unit 23 upon switch to the “Help mode” at Step S106F.

When a voice indicating that the way to operate is unclear is input (Step S106D: Yes), and switching to the “Help mode” is performed (Step S106F), the display controller 324A displays the parameter selection screen W204 illustrated in FIG. 9 on the display unit 23.

Specifically, the parameter selection screen W204 is an image in which a title image TL4, directional images Ar1 to Ar3, and description images D1 to D3 are arranged in the screen.

In the example in FIG. 9, a text “Need help?” is displayed as the title image TL4.

The directional images Ar1 to Ar3 are images that correspond to the rotation directions of the lens operating unit 41 and indicate operation directions for selecting the “MF mode”, the “exposure correction mode”, and the “zoom mode”, respectively.

The description images D1 to D3 are images for describing modes to be selected by the ring operation and the touch operation in the operation directions based on the directional images Ar1 to Ar3. In the example in FIG. 9, a text “defocused” corresponding to the “MF mode”, a text “want to change brightness” corresponding to the “exposure correction mode”, and a text “want to change size” corresponding to the “zoom mode” are displayed as the description images D1 to D3, respectively.

Incidentally, FIG. 9 illustrates a state in which the description image D1 is selected and the display controller 324A displays the description image D1 in a highlighted manner (indicated by diagonal lines in FIG. 9).

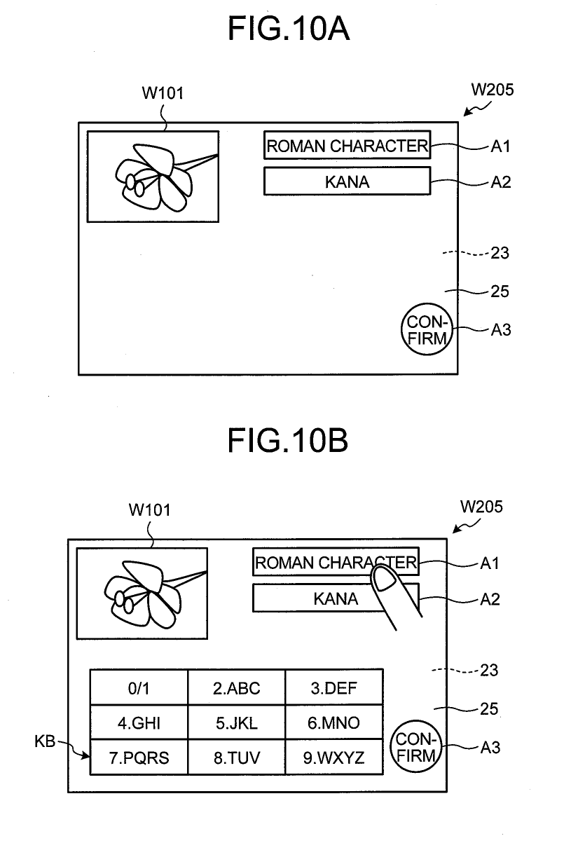

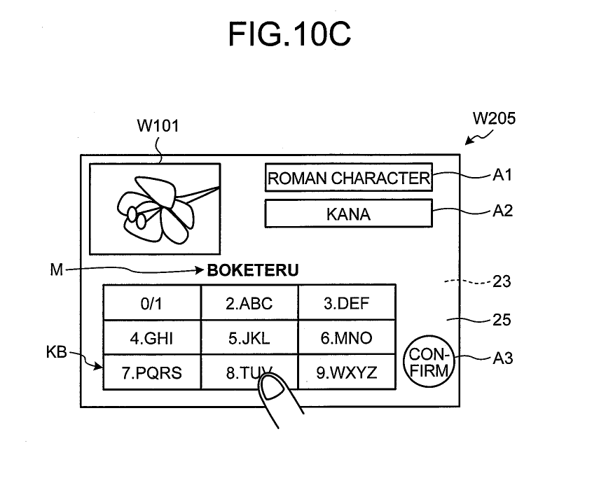

FIG. 10A to FIG. 100 are diagrams illustrating examples of a keyboard input screen W205 displayed on the display unit 23 upon switch to the “keyboard mode” at Step S106F.

When a voice indicating that a message is to be written is input (Step S106D: Yes), and switching to the “keyboard mode” is performed (Step S106F), the display controller 324A displays the keyboard input screen W205 illustrated in FIG. 10A to FIG. 10C on the display unit 23.

Specifically, the keyboard input screen W205 is an image in which the live view image W101, a Roman character input icon A1, a Japanese kana input icon A2, a confirmation icon A3, a keyboard input icon KB (FIG. 10B and FIG. 10C), and a message display area M (FIG. 10C) are arranged in the screen.

The live view image W101 is an image obtained by reducing the live view image W100.

The Roman character input icon A1 is an icon for receiving input of an instruction signal to display a keyboard input icon KB for inputting Roman characters in the keyboard input screen W205.

The Japanese kana input icon A2 is an icon for receiving input of an instruction signal to display a keyboard input icon for inputting Japanese kana (not illustrated) in the keyboard input screen W205.

The message display area M is an area for displaying a message input by the user by a touch operation on the keyboard input icon KB.

The keyboard input icon KB is an icon for receiving input of instruction signals to cause characters to be input, and two types of icons are provided, one of which is the keyboard input icon KB for inputting Roman characters and the other one is a keyboard input icon for inputting Japanese kana (not illustrated).

In the keyboard input screen W205 illustrated in FIG. 10B and FIG. 10C, the keyboard input icon KB for inputting Roman characters is displayed.

The keyboard input icon KB for inputting Roman characters is an icon that enables input of messages in Roman characters, and is displayed when the Roman character input icon A1 is selected.

The keyboard input icon for inputting Japanese kana (not illustrated) is an icon that enables input of messages in Japanese kana, and is displayed when the Japanese kana input icon A2 is selected.

The confirmation icon A3 is an icon for receiving input of an instruction signal to confirm an input message.

As described above, after a mode is switched to the mode corresponding to the input specific voice and display of any of the images W201 to W205 corresponding to the mode on the display unit 23 (Step S106F), the imaging apparatus 1 returns to the main routine illustrated in FIG. 4.

Referring back to Step S106D, when the specific voice has not been input (Step S106D: No); the parameter change unit 324B determines whether the operation specifying unit 323 has set the change operation input unit (whether information set by the operation specifying unit 323 is stored in the SDRAM 28) (Step S106G).

If the process at Step S106E has not been performed and the operation specifying unit 323 has not set the change operation input unit (Step S106G: No), the imaging apparatus 1 returns to the main routine illustrated in FIG. 4.

In contrast, when determining that the operation specifying unit 323 has set the change operation input unit (Step S106G: Yes), the parameter change unit 324B performs the parameter change process (Step S106H). Thereafter, the imaging apparatus 1 returns to the main routine illustrated in FIG. 4.

Namely, the parameter change process (Step S106H) is performed when, after a mode is switched to the mode corresponding to the input specific voice in the voice handling process (Step S106) and the process returns to the main routine illustrated in FIG. 4, the user performs the ring operation (Step S104: Yes) or the touch operation (Step S105: Yes) and then the voice handling process (Step S106) is performed again.

### Parameter Change Process

The parameter change process (Step S106H) will be described below for each of the “MF mode”, the “exposure correction mode”, the “zoom mode”, the “Help mode”, the “keyboard mode”, and the “initialization mode”, in relation to the ring operation and the touch operation performed by the user.

### Parameter Change Process in MF Mode

The user checks the live view image W100 (FIG. 5) before performing a shooting operation. In some cases, the user may want to change the focus state of an image, but may not know how to operate and may say words related to the focus state of the image (for example, “defocused” or the like) while performing a ring operation with a left hand.

In such a case, because the specific voice has been input (Step S106D: Yes), the lens operating unit 41 is set as the change operation input unit (Step S106E). Furthermore, a mode is switched to the “MF mode”, and the live view image W201 illustrated in FIG. 8A is displayed on the display unit 23 (Step S106F).

Thereafter, if the user wants to focus on a short distance for example, the user finds the description image DR1 displaying a text “short distance” in the live view image W201 illustrated in FIG. 8A. Then, the user performs the ring operation, which he/she has been performing, in the operation direction (the direction of the arrow R1 (FIG. 6A)) based on the directional image AR indicating the description image DR1.

As described above, the lens operating unit 41 is set as the change operation input unit. Therefore, the parameter change unit 324B changes the shooting parameters (the focal point and the focal distance) to values for the short distance in accordance with the ring operation in the parameter change process (Step S106H).

If the user wants to focus on a far distance, and when the user performs the ring operation in the operation direction (the direction of the arrow R2 (FIG. 6A)) based on the directional image AL, the parameter change process (Step S106H) is performed so that the shooting parameters (the focal point and the focal distance) can be changed to values for the far distance.

Furthermore, the focus state of the live view image W100 is also changed with a change in the shooting parameters. Therefore, the user performs the above described ring operation until a desired focus state is obtained while checking the live view image W201 containing the live view image W100.

If the user says words related to the focus state of the image while performing a touch operation by sliding a finger on the touch panel 25, the touch panel 25 is set as the change operation input unit at Step S106E.

In this case, when the user performs the touch operation by sliding a finger along the directional image AR or the directional image AL on the touch panel 25, the parameter change process (Step S106H) is performed so that the shooting parameters (the focal point and the focal distance) can be changed.

Namely, the parameter change unit 324B changes the shooting parameters according to a user operation performed on the change operation input unit, and does not change the shooting parameters according to user operations on other operation input units.

### Parameter Change Process in Exposure Correction Mode

The user checks the live view image W100 (FIG. 5) before performing a shooting operation. In some cases, the user may want to change the exposure state of an image, but may not know how to operate and may say words related to the exposure state of the image (for example, “I want to make it brighter” or the like) while performing a ring operation with a left hand.

In such a case, because the specific voice has been input (Step S106D: Yes), the lens operating unit 41 is set as the change operation input unit (Step S106E). Furthermore, a mode is switched to the “exposure correction mode”, and the live view image W202 illustrated in FIG. 8B is displayed on the display unit 23 (Step S106F).

Thereafter, if the user wants to make the image brighter for example, the user finds the description image DR2 displaying a text “bright” in the live view image W202 illustrated in FIG. 8B. Then, the user performs the ring operation, which he/she has been performing, in the operation direction (the direction of the arrow R1 (FIG. 6A)) based on the directional image AR indicating the description image DR2.

In response to the ring operation, the parameter change unit 324B changes the shooting parameter (exposure value) to a value that makes the image brighter in the parameter change process (Step S106H).

If the user wants to make the image darker, and when the user performs the ring operation in the operation direction (the direction of the arrow R2 (FIG. 6A)) based on the directional image AL, the parameter change process (Step S106H) is performed so that the shooting parameter (exposure value) can be changed to a value that makes the image darker.

If the user says words related to the exposure state of the image while performing a touch operation by sliding a finger on the touch panel 25, the touch panel 25 is set as the change operation input unit at Step S106E.

In this case, when the user performs the touch operation by sliding a finger along the directional image AR or the directional image AL on the touch panel 25, the parameter change process (Step S106H) is performed so that the shooting parameter (exposure value) can be changed.

### Parameter Change Process in Zoom Mode

The user checks the live view image W100 (FIG. 5) before performing a shooting operation. In some cases, the user may want to change the shooting range, but may not know how to operate and may say words related to the shooting range (for example, “I want to make it bigger” or the like) while performing a ring operation with a left hand.

In such a case, because the specific voice has been input (Step S106D: Yes), the lens operating unit 41 is set as the change operation input unit (Step S106E). Furthermore, a mode is switched to the “zoom mode”, and the live view image W203 illustrated in FIG. 8C is displayed on the display unit 23 (Step S106F).

Thereafter, if the user wants to capture the subject S in a larger size for example, the user finds the description image DR3 displaying a text “large” in the live view image W203 illustrated in FIG. 8C. Then, the user performs the ring operation, which he/she has been performing, in the operation direction (the direction of the arrow R1 (FIG. 6A)) based on the directional image AR indicating the description image DR3.

In response to the ring operation, the parameter change unit 324B changes the shooting parameter (the zoom magnification) to a greater value in the parameter change process (Step S106H).

If the user wants to capture the subject S in a smaller size, and when the user performs the ring operation in the operation direction (the direction of the arrow R2 (FIG. 6A)) based on the directional image AL, the parameter change process (Step S106H) is performed so that the shooting parameter (the zoom magnification) can be changed to a smaller value.

If the user says words related to the shooting range while performing a touch operation by sliding a finger on the touch panel 25, the touch panel 25 is set as the change operation input unit at Step S106E.

In this case, when the user performs the touch operation by sliding a finger along the directional image AR or the directional image AL on the touch panel 25, the parameter change process (Step S106H) is performed so that the shooting parameter (the zoom magnification) can be changed.

### Parameter Change Process in Help Mode

The user checks the live view image W100 (FIG. 5) before performing a shooting operation. In some cases, the user may want to change the focus state or the exposure state of an image or the shooting range, but may not know how to operate and may say words indicating that the way to operate is unclear (for example, “What should I do?” or the like) while performing a ring operation with a left hand.

In such a case, because the specific voice has been input (Step S106D: Yes) in the voice handling process (Step S106), the lens operating unit 41 is set as the change operation input unit (Step S106E). Furthermore, a mode is switched to the “Help mode”, and the parameter selection screen W204 illustrated in FIG. 9 is displayed on the display unit 23 (Step S106F).

Thereafter, if the user wants to change the exposure state of the image for example, the user finds the description image D2 displaying a text “want to change brightness” in the parameter selection screen W204 illustrated in FIG. 9. Then, the user performs the ring operation, which he/she has been performing, in the operation direction (the direction of the arrow R2 (FIG. 6A)) based on the directional image Ar3 for switching from the currently selected description image D1 to the description image D2.

As described above, the lens operating unit 41 is set as the change operation input unit. Therefore, the function execution unit 324 selects the description image D2 according to the ring operation and displays the description image D2 in a highlighted manner.

After a predetermined time has elapsed since the selection of the description image D2, the function execution unit 324 switches to the “exposure correction mode” corresponding to the selected description image D2.

If the user wants to change the focus state of the image or the shooting range, and when the user selects the description image D1 or the description image D3 by the ring operation, the above described process is performed by the function execution unit 324 to switch to the “MF mode” or the “zoom mode”.

The parameter change processes performed after the switch to the “MF mode”, the “exposure correction mode”, and the “zoom mode” are the same as the above described “parameter change process in MF mode”, “parameter change process in exposure correction mode”, and “parameter change process in zoom mode”, respectively.

If the user says words indicating that the way to operate is unclear while performing a touch operation by sliding a finger on the touch panel 25, the touch panel 25 is set as the change operation input unit at Step S106E.

In this case, when the user performs the touch operation by sliding a finger along any of the directional images Ar1 to Ar3 on the touch panel 25, the above described process is performed by the function execution unit 324 and any of the description images D1 to D3 can be selected.

Namely, the function execution unit 324 selects any of the description images D1 to D3 according to a user operation on the change operation input unit, and does not select any of the description images D1 to D3 according to user operations on other operation input units.

### Parameter Change Process in Keyboard Mode

The user checks the live view image W100 (FIG. 5) before performing a shooting operation. In some cases, the user may want to change the focus state or the exposure state of an image or the shooting range, but may not know how to operate and may say words indicating that a message is to be written (for example, “tweets” or the like) while performing a ring operation or a touch operation.

In such a case, because the specific voice has been input (Step S106D: Yes), the touch panel 25 is set as the change operation input unit (Step S106E). Furthermore, a mode is switched to the “keyboard mode”, and the keyboard input screen W205 illustrated in FIG. 10A is displayed on the display unit 23 (Step S106F).

Thereafter, if the user wants to change the focus state of the image for example, the user inputs a message related to the focus state of the image (for example, “defocused” or the like) to the keyboard input screen W205.

Specifically, when the user inputs a message “BOKETERU” in Roman characters, following touch operations are performed.

First, the user selects the Roman character input icon A1 by a touch operation.

In response to this touch operation, the display controller 324A displays the keyboard input icon KB for inputting Roman characters in the keyboard input screen W205 as illustrated in FIG. 10B.

The user performs touch operations three times on a display area of “2.ABC” and performs touch operations four times on a display area of “6.MNO” in the keyboard input icon KB to input “BO”.

Subsequently, the user performs touch operations three times on a display area of “5.JKL” and performs touch operations three times on a display area of “3.DEF” to input “KE”.

Then, the user performs touch operations twice on a display area of “8.TUV” and performs touch operations three times on a display area of “3.DEF” to input “TE”.

Finally, the user performs touch operations four times on a display area of “7.PQRS” and performs touch operations three times on a display area of “8.TUV” to input “RU”.

In response to the above described touch operations, the display controller 324A displays a text “BOKETERU” in the message display area M (FIG. 10C).

The user checks the message in the message display area M, and when determining that the input contents are correct, selects the confirmation icon A3 by a touch operation.

In response to this touch operation, the function execution unit 324 determines whether a specific message (a message corresponding to a specific voice contained in the related information RI) has been input. In the above example, because the message “BOKETERU” is a specific message, the function execution unit 324 switches to the “MF mode” corresponding to this specific message.

When the user inputs a message related to the exposure state of the image (for example, “I want to make it brighter.” or the like), a message related to the shooting range (for example, “I want to make it bigger” or the like), or a message indicating that the way to operate is unclear (for example, “What should I do?” or the like), the above described process is performed by the function execution unit 324 and a mode can be switched to the “exposure correction mode”, the “zoom mode”, or the “Help mode”.

The parameter change processes performed after the switch to the “MF mode”, the “exposure correction mode”, the “zoom mode”, and the “Help mode” are the same as the above described “parameter change process in MF mode”, “parameter change process in exposure correction mode”, “parameter change process in zoom mode”, and “parameter change process in Help mode”, respectively.

### Parameter Change Process in Initialization Mode

In some cases, while the user is changing the shooting parameters in the “MF mode”, the “exposure correction mode”, or the “zoom mode”, an image may not be changed to a desired state, and the user may say negative words (for example, “different” or the like) while performing a ring operation or a touch operation.

In such a case, because the specific voice has been input (Step S106D: Yes), the lens operating unit 41 or the touch panel 25 that has been performed is set as the change operation input unit (Step S106E). Furthermore, a mode is switched to the “initialization mode” (Step S106F).

When the user re-performs the ring operation or the touch operation that the user has performed, the parameter change unit 324B initializes the shooting parameters that have been changed in the “MF mode”, the “exposure correction mode”, or the “zoom mode” in the parameter change process (Step S106H) to default values. Thereafter, the function execution unit 324 terminates the “MF mode”, the “exposure correction mode”, or the “zoom mode”.

The same applies to the case where the user says negative words while performing the ring operation or the touch operation in the “Help mode” or the “keyboard mode” and re-performs the ring operation or the touch operation that the user has been performing. Namely, the shooting parameters are initialized to the default values through the parameter change process (Step S106H), and the “Help mode” or the “keyboard mode” is terminated.

Steps S106F and S106H as described above correspond to a function execution step according to the present invention.

According to the imaging apparatus 1 of the above described first embodiment, the voice processing unit 22 is operated according to a ring operation or a touch operation, words (voice) of complaints said by the user are acquired, and voice data based on the voice is generated. Furthermore, according to the imaging apparatus 1 of the first embodiment, it becomes possible to determine, based on the voice data, whether a specific voice contained in the related information RI recorded in advance in the flash memory 29 has been input, and execute a function corresponding to the specific voice when the specific voice has been input (a function of changing the shooting parameters according each mode, such as the “MF mode”).

Therefore, according to the imaging apparatus 1 of the first embodiment, it becomes possible to easily execute functions desired by a user who is not familiar with operations.

Furthermore, in the first embodiment, a plurality of operation input units (the lens operating unit 41 and the touch panel 25) are employed as operation input units that trigger operations of the voice processing unit 22.

Therefore, according to the imaging apparatus 1 of the first embodiment, because the plurality of the operation input units are provided so as to be performed by a user when he/she does not know how to operate, it becomes possible to reliably acquire words said by the user and reliably execute functions desired by the user.

Moreover, in the first embodiment, the imaging apparatus 1 specifies the lens operating unit 41 or the touch panel 25 as an operation input unit that has received a user operation by which input of a specific voice has been triggered, and sets the specified operation input unit as the change operation input unit. Then, when the user operates the change operation input unit in the “MF mode”, the “exposure correction mode”, the “zoom mode”, the “Help mode”, or the “initialization mode”, the imaging apparatus 1 changes the shooting parameters.

Therefore, according to the imaging apparatus 1 of the first embodiment, the user is able to change the shooting parameters without shifting the left hand holding the imaging apparatus 1.

Furthermore, in the first embodiment, when the user inputs a voice, such as “Oh, no!” or “What should I do?”, indicating that the way to operate is unclear, the imaging apparatus 1 switches to the “Help mode” and displays the parameter selection screen W204 on the display unit 23.

Therefore, according to the imaging apparatus 1 of the first embodiment, even when the user does not known terms related to the exposure state or the focus state of an image or related to the shooting range, the parameter selection screen W204 is displayed by saying words indicating that the way to operate is unclear. Therefore, it becomes possible to change the exposure state or the focus state of an image or the shooting range.

Furthermore, in the first embodiment, the imaging apparatus 1 operates the voice processing unit 22 for a predetermined time since a start of the ring operation or the touch operation and acquires words (voice) said by the user.

Therefore, according to the imaging apparatus 1 of the first embodiment, even when the user stops the ring operation or the touch operation while saying words, it becomes possible to acquire almost all of words said by the user, enabling to reliably execute functions desired by the user.

### Second Embodiment

A second embodiment of the present invention will be described.

In the explanation below, the same configurations and steps as those of the first embodiment are denoted by the same reference symbols, and detailed explanation thereof will be omitted or simplified.

In the above described first embodiment, in the voice handling process (Step S106), the operation controller 321 operates the voice processing unit 22 for a predetermined time since a start of the ring operation or the touch operation. The voice determination unit 322 determines whether a specific voice has been input by using voice data generated based on voices input during the predetermined time.

In contrast, in a voice handling process according to the second embodiment, the voice processing unit 22 is operated only while the ring operation or the touch operation is continued. In the voice handling process according to the second embodiment, a plurality of pieces of voice data generated by the voice processing unit 22 by intermittently performing the ring operation or the touch operation are concatenated in chronological order to generate concatenated voice data, and whether a specific voice has been input is determined by using the concatenated voice data.

The configuration of an imaging apparatus according to the second embodiment is the same as that of the above described first embodiment.

In the following, only the voice handling process according to the second embodiment (Step S106 in FIG. 4) will be described.

### Voice Handling Process

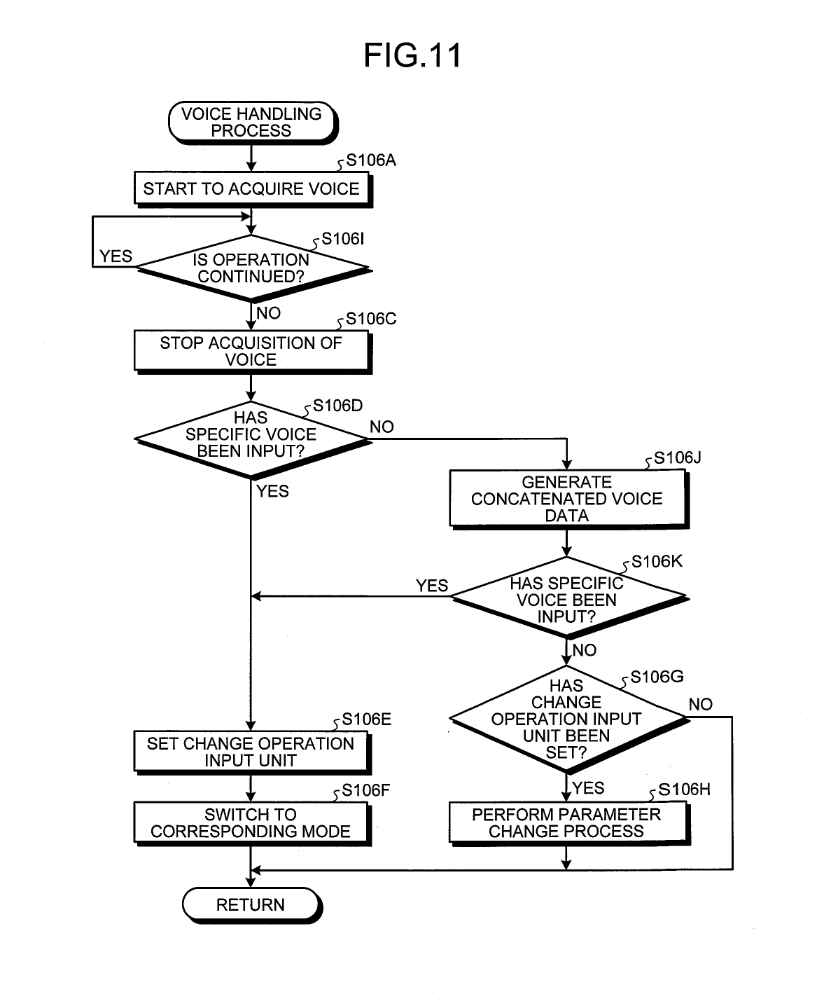

FIG. 11 is a flowchart illustrating an overview of the voice handling process according to the second embodiment.

The voice handling process according to the second embodiment differs from the voice handling process of the above described first embodiment (FIG. 7) only in that, as illustrated in FIG. 11, Step S106B is changed to Step S106I and Steps S106J and S106K are added. Therefore, in the following, only the differences will be described.

### Step S106I

At Step S106I, the operation controller 321 according to the second embodiment always monitors, after a start of operations of the voice processing unit 22 (Step S106A), whether a ring operation or a touch operation is continued, that is, whether an operation such as the ring operation or the touch operation is performed on an operating member during a predetermined time set in advance. If the ring operation or the touch operation is not performed during the predetermined time, the operation controller 321 determines that the operation such as the ring operation or the touch operation on the operating member is stopped (Step S106I: No), and stops the operation of the voice processing unit 22 at Step S106C.

Steps S106A, S106I, and S106C as described above correspond to an operation control step according to the present invention.

### Step S106J

At Step S106D, the voice determination unit 322 according to the second embodiment reads, as the latest voice data and from the SDRAM 28, the latest word recorded when the operation such as the ring operation or the touch operation is performed on the operating unit during the predetermined time set in advance, and analyzes the read voice data. Specifically, the voice determination unit 322 determines whether the latest voice data contains a specific voice contained in the related information RI recorded in the flash memory 29 (whether a specific voice has been input). In general, word data in this case is likely to correspond to words obtained when the user has a complaint and make complains (say words of complaints or the like) as described above with reference to FIG. 6A or FIG. 6B. Therefore, the voice determination unit 322 has a function as a complaint determination unit according to the present invention, which determines whether the latest voice data contains a user's complaint.

Incidentally, in the second embodiment, a predetermined number of pieces of voice data generated by the voice processing unit 22 (voice data generated while the user is performing a single ring operation or touch operation) are sequentially stored in the SDRAM 28. In other words, when the voice data generated by the voice processing unit 22 is stored in the SDRAM 28, the oldest voice data is deleted from the predetermined number of pieces of the voice data that have been stored.

When determining that the latest voice data does not contain a specific voice (Step S106D: No), the voice determination unit 322 proceeds to Step S106J.

At Step S106J, the voice determination unit 322 reads the predetermined number of pieces of voice data older than the latest voice data from the SDRAM 28, and generates concatenated voice data by concatenating the predetermined number of pieces of the voice data in chronological order. Thereafter, the imaging apparatus 1 proceeds to Step S106K.

### Step S106K

At Step S106K, the voice determination unit 322 analyzes the above described concatenated voice data. The voice determination unit 322 determines whether the concatenated voice data contains a specific voice that is the related information RI recorded in the flash memory 29 (whether a specific voice has been input).

When determining that the specific voice is contained in the concatenated voice data contains (Step S106K: Yes), the imaging apparatus 1 proceeds to Step S106E.

In contrast, when determining that the specific voice is not contained in the concatenated voice data contain (Step S106K: No), the imaging apparatus 1 proceeds to Step S106G.

As described in the second embodiment, even in the case where whether the specific voice has been input is determined by using the concatenated voice data, the same advantageous effects as those of the first embodiment can be achieved.

### Other Embodiments

While the embodiments of the present invention have been explained above, the present invention is not limited to the above described first and second embodiments.

In the above described first and second embodiments, it may be possible to display a message that helps to operate the change operation input unit set by the operation specifying unit 323 on the live view images W201 to W203 (FIG. 8A to FIG. 8C) and the parameter selection screen W204 (FIG. 9).

For example, examples of the message include “perform ring operation” when the lens operating unit 41 serves as the change operation input unit, and “perform touch operation” when the touch panel 25 serves as the change operation input unit.

In the above described first and second embodiments, the related information RI illustrated in FIG. 3 is an example. The information may be information in which other voices and modes contained in the related information RI illustrated in FIG. 3 are associated with one another, or information in which other voices and other modes are associated with one another.

In the above described first and second embodiments, the modes switched by the function execution unit 324 are not limited to the modes explained in the above described first and second embodiments. For example, it may be possible to employ modes for changing an ISO sensitivity, a white balance, and the like that are other shooting parameters.

In the above described first and second embodiments, the lens operating unit 41 and the touch panel 25 are employed as the operation input units according to the present invention; however it is not thus limited. For example, it may be possible to employ a mechanical switch included in the input unit 20 as the operation input unit according to the present invention.

In the above described first and second embodiments, for example, the main body 2 and the lens unit 3 may be formed integrally.

Furthermore, the present invention is applicable to, apart from a digital single lens reflex camera, a digital camera on which an accessory or the like is mountable, a digital video camera, or an electronic device such as a mobile phone or a tablet type mobile device having an imaging function. Moreover, the present invention is effectively applicable to mobile devices provided with operation input units that can be operated by hands while words are said by murmuring (tweeting) or the like, and, of course, applicable to in-vehicle, medical, or industrial devices that can be operated by natural voices said by users, in addition to the mobile devices. In such a case, the present invention is not limited to the mobile devices. Furthermore, it may be possible to assist users in, in addition to the ring operation, operations of a lever, a slid switch, a rotary dial, a touch panel, and the like based on situations in which words are said while these units are moved or operated. Moreover, when operation input units output specific operating sounds, it is of course possible to cancel the sounds as audio noise and analyze voices by extracting keywords or the like.

Moreover, the process flows are not limited to the sequences of the processes in the flowcharts described in the above described first and second embodiments, but may be modified as long as there is no contradiction.

Furthermore, algorithms of the processes in the flowcharts described in the present specification may be written as programs. Such programs may be recorded in a recording unit inside a computer or may be recorded in a computer readable recording medium. The programs may be recorded in the recording unit or the recording medium when the computer or the recording medium is shipped as a product or may be downloaded via a communication network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic device comprising:
an operation input unit that receives a user operation;
a voice data generation unit that generates voice data based on an input voice;
an operation controller that operates the voice data generation unit while the user operation is continued and causes the voice data generation unit to generate voice data;
a related information recording unit that records related information in which a specific voice and a specific function are associated with each other;
a voice determination unit that analyzes the voice data generated by the voice data generation unit and determines whether the specific voice contained in the related information has been input; and
a function execution unit that, when the voice determination unit determines that the specific voice has been input, executes the function associated with the input specific voice based on the related information.

2. The electronic device according to claim 1, further comprising:
a plurality of the operation input units; and
an operation specifying unit that, when the voice determination unit determines that the specific voice has been input, specifies an operation input unit that has received a user operation by which input of the specific voice has been triggered from among the operation input units, wherein
the function execution unit includes a parameter change unit that changes a parameter for setting an operation of the electronic device, and
the parameter change unit changes the parameter according to the user operation on the operation input unit specified by the operation specifying unit.

3. The electronic device according to claim 2, further comprising an imaging unit that generates image data of a subject image, wherein the parameter is a shooting parameter related to an imaging condition of the imaging unit.

4. The electronic device according to claim 2, further comprising a display unit that displays a screen, wherein the function execution unit includes a display controller that displays, on the display unit, a parameter change screen for changing the parameter.

5. The electronic device according to claim 4, wherein
a plurality of types of the parameters are provided, and
the display controller displays, on the display unit, a parameter selection screen for selecting a parameter to be changed from among the plurality of types of the parameters.

6. The electronic device according to claim 1, further comprising:
an imaging unit that generates image data of a subject image; and
a lens unit that houses an optical system that focuses the subject image, wherein
the operation input unit includes a ring operating member that is arranged on the lens unit and that is rotatable about an optical axis of the optical system.

7. The electronic device according to claim 1, further comprising a display unit that displays a screen, wherein the operation input unit includes a touch panel that is arranged on a display screen of the display unit, that detects touch of an external object, and that outputs a signal corresponding to the detected touch.

8. The electronic device according to claim 1, wherein the voice determination unit generates concatenated voice data by concatenating a plurality of pieces of voice data generated by the voice data generation unit in chronological order, and determines whether the specific voice has been input by analyzing the concatenated voice data.

9. An electronic device comprising:
an operation input unit that receives a user operation;
a voice acquisition unit that acquires a voice said by a user while the user is operating the operation input unit;
a voice data generation unit that generates voice data based on the voice acquired by the voice acquisition unit;
a complaint determination unit that determines whether the voice data generated by the voice data generation unit contains voice data corresponding to a complaint said by the user;
a function display unit that, when the complaint determination unit determines that the voice data corresponding to the complaint said by the user is contained, displays a function for resolving the complaint said by the user based on the voice data; and
a function execution unit that, when a predetermined function displayed on the function display unit is selected, executes the selected function.

10. The electronic device according to claim 9, further comprising a related information recording unit that records related information in which a voice corresponding to a specific complaint and a function for resolving the specific complaint are associated with each other, wherein the complaint determination unit analyzes the voice data generated by the voice data generation unit, and when the analyzed voice data contains the voice data corresponding to the specific complaint contained in the related information recorded in the related information recording unit, determines that the voice data corresponding to the complaint said by the user is contained.

11. The electronic device according to claim 9, wherein the function display unit displays, as the function for resolving the complaint said by the user, a parameter change screen corresponding to the complaint said by the user.

12. The electronic device according to claim 11, wherein the parameter change screen is a screen for changing a shooting parameter to change an imaging condition.

13. The electronic device according to claim 12, wherein the operation input unit is one of a rotatable ring operating member and a touch panel that is arranged on a display screen of the function display unit, that detects touch of an external object, and that outputs a signal corresponding to the detected touch.

14. A control method performed by an electronic device, comprising:
operating a voice data generation unit while a user operation on an operation input unit is continued thereby causing the voice data generation unit to generate voice data;
analyzing the voice data generated by the voice data generation unit to determine whether a specific voice contained in related information has been input, the related information being information in which the specific voice and a specific function are associated with each other; and
executing, when it is determined that the specific voice has been input, the function associated with the input specific voice based on the related information.

15. A control method performed by an electronic device, comprising:
determining a user operation performed on a specific operation input unit;
operating a voice data generation unit while the user operation on the specific operation input unit is continued thereby causing the voice data generation unit to generate voice data;
analyzing the voice data generated by the voice data generation unit to determine whether the voice data contains a specific keyword; and
executing, when it is determined that the specific keyword is contained, the function associated with the specific keyword according to the user operation on the specific operation input unit.

16. A control method performed by an electronic device, comprising:
acquiring a voice said by a user while the user is operating an operation input unit;
generating voice data based on the acquired voice;
determining whether the generated voice data contains voice data corresponding to a complaint said by the user;
displaying, when it is determined that the voice data corresponding to the complaint said by the user is contained, a function for resolving the complaint said by the user based on the voice data; and
executing a function selected by the user; wherein
in the acquiring, the generating, the determining, the displaying, and the executing, the complaint said by the user is recognized based on the voice said by the user and the function desired by the user is displayed to aid the user to select the function, thereby the complaint said by the user who is not familiar with an operation is resolved.

17. A non-transitory computer readable recording medium having an executable program recorded thereon, the program instructing a processor, which is included in an electronic device, to execute:
operating a voice data generation unit while a user operation on an operation input unit is continued thereby causing the voice data generation unit to generate voice data;
analyzing the voice data generated by the voice data generation unit to determine whether a specific voice contained in related information has been input, the related information being information in which the specific voice and a specific function are associated with each other; and
executing, when it is determined that the specific voice has been input, the function associated with the input specific voice based on the related information.

18. A non-transitory computer readable recording medium having an executable program recorded thereon, the program instructing a processor, which is included in an electronic device, to execute:
determining a user operation performed on a specific operation input unit;
operating a voice data generation unit while the user operation on the specific operation input unit is continued thereby causing the voice data generation unit to generate voice data;
analyzing the voice data generated by the voice data generation unit to determine whether the voice data contains a specific keyword; and
executing, when it is determined that the specific keyword is contained, the function associated with the specific keyword according to the user operation on the specific operation input unit.

19. A non-transitory computer readable recording medium having an executable program recorded thereon, the program instructing a processor, which is included in an electronic device, to execute:
acquiring a voice said by a user while the user is operating an operation input unit;
generating voice data based on the acquired voice;
determining whether the generated voice data contains voice data corresponding to a complaint said by the user;
displaying, when it is determined that the voice data corresponding to the complaint said by the user is contained, a function for resolving the complaint said by the user based on the voice data; and
executing a function selected by the user; wherein
in the acquiring, the generating, the determining, the displaying, and the executing, the complaint said by the user is recognized based on the voice said by the user and the function desired by the user is displayed to aid the user to select the function, thereby the complaint said by the user who is not familiar with an operation is resolved.
